(19) United States
(12) Patent Application Publication
(10) Pub. No.: US 2024/0312658 A1
(43) Pub. Date: Sep. 19, 2024

(54) Control Apparatus and Control Method of Power Generation Plant

(71) Applicant: Hitachi-GE Nuclear Energy, Ltd., Hitachi-shi (JP)

(72) Inventors: Yohei MURAKAMI, Tokyo (JP); Shunya Morita, Hitachi-shi (JP)

(21) Appl. No.: 18/604,134

(22) Filed: Mar. 13, 2024

(30) Foreign Application Priority Data
Mar. 14, 2023 (JP) 2023-039411

(51) Int. Cl. G21D 3/04; G21D 3/00

(52) U.S. Cl. CPC G21D 3/04; G21D 3/001

(57) ABSTRACT

The supply amount of reactive power can be expanded while the soundness of a nuclear reactor and a BOP. A control apparatus of a power generation plant connected to a power system including a power system stability degree previous evaluation unit that evaluates a stability degree at the time of the predicted failure of the power system, a nuclear power safety evaluation unit, and a current day power generation control instruction unit that corrects a required power supply amount given from the outside according to the evaluation result of the power system stability degree previous evaluation unit and the evaluation result of the nuclear power safety evaluation unit, in which the generated power of the power generation plant is adjusted by a signal from the current day power generation control instruction unit.

### CLAIM OF PRIORITY

The present application claims priority from Japanese Patent application serial no. 2023-039411 filed on Mar. 14, 2023, the content of which is hereby incorporated by reference into this application.

### BACKGROUND OF THE INVENTION

The present invention relates to a control apparatus and a control method of a power generation plant.

The introduction of renewable energy RE (Renewable Energy) has been advanced worldwide toward achieving a decarbonized society, but a power system to which the renewable energy RE is coupled is predicted to cause various problems, such as supply and demand balance, excess of power transmission capacity, voltage variation, frequency variation, and stability. This is caused due, for example, to that the output of variable renewable energy VRE (Variable Renewable Energy), such as sunlight and wind power generation, is influenced by the ever-changing weather condition, to that the system inertia is decreased due to the reduction in the number of synchronous power generators of a thermal power generation plant, and to that since the appropriate place of the sunlight and wind power generation is limited, the power transmission capacity when the power is delivered from the power generating place of the variable renewable energy VRE to the demanding place thereof is increased to be likely to cause a local overload in the power transmission line.

For such the problems, system strengthening plans for stably delivering the power by the variable renewable energy VRE from the supplying place to the demanding place have been made, but making the cost for these system strengthening plans huge has been a problem. In this way, not only by simply increasing the rate of the variable renewable energy VRE, but also by advancing the control of the existing facility in a state where the stability and the economy are also required to be considered at the same time, it is important to ensure the stability of the power system while suppressing the investment.

For advancing the control of the existing facility, the power factor adjustment of a power generator is given. The power factor adjustment is to adjust the supply ratio between the active power and the reactive power of the power generated by the power supply. The active power is, for example, power consumed to operate a household appliance product. The reactive power is not consumed as power, but has an effect of maintaining the voltage of the power system by being inputted to and outputted from the power supply according to the state of the system.

In recent years, a reactive power control method by which the supply amount of the reactive power supplied from the power generator is increased as compared with the conventional art has been studied. This reactive power control method will be described with reference to FIG. 1. FIG. 1 illustrates the position relationship between a power generator G that supplies the reactive power, voltage in power generation plant V1, and voltage in power substation past power transmission line to which power generation plant is connected V2. Conventionally, the power generator has supplied the reactive power so as to maintain the voltage in power generation plant V1. However, to stabilize the voltage of the power system, the voltage in power substation V2 is required to be maintained. For that, for example, Japanese Unexamined Patent Application Publication No. 2022-134639 proposes the reactive power control method by which the voltage of the power generator G is maintained while the voltage in power substation V2 is monitored, such that the voltage in power substation V2, not the voltage in power generation plant V1, is maintained.

### SUMMARY OF THE INVENTION

As described in the background art, proposed is the reactive power control method by which the reactive power supply amounts of the thermal power generator and the nuclear power generator are decided by referring to the voltage value of the power substation to which they are connected. However, in the control of the power generator, its operation pattern can also have a significant influence on the operation of the power generation plant.

Specifically, in the nuclear power generation plant, the change of the operation pattern of the power generator has an influence on the operation of the nuclear reactor and the BOP (Balance Of Plant). For that, there is a problem that when the operation of the power generator is changed by a signal from the outside power substation that is not able to recognize the operation state of the nuclear reactor and the BOP in the power generation plant, this change can have an influence on the soundness of the nuclear reactor and the BOP in the power generation plant.

From this, an object of the present invention is to provide a control apparatus and a control method of a power generation plant in which the supply amount of reactive power can be expanded while the soundness of a nuclear reactor and a BOP is maintained.

From the above, the present invention provides “a control apparatus of a power generation plant connected to a power system including a power system stability degree previous evaluation unit that evaluates a stability degree at the time of the predicted failure of the power system, a nuclear power safety evaluation unit that evaluates soundness related to the operation of a nuclear power generation plant, and a current day power generation control instruction unit that corrects a required power supply amount given from the outside according to the evaluation result of the power system stability degree previous evaluation unit and the evaluation result of the nuclear power safety evaluation unit, and decides the operation pattern of the generated power of the power generation plant on the current day, in which the generated power of the power generation plant is adjusted by a signal from the current day power generation control instruction unit”.

In addition, the present invention provides “a control method of a power generation plant connected to a power system by using a calculator device, in which a calculation unit of the calculator device includes the functions of a power system stability degree previous evaluation process that evaluates a stability degree at the time of the predicted failure of the power system, a nuclear power safety evaluation process that evaluates soundness related to the operation of a nuclear power generation plant, and a current day power generation control instruction process that corrects a required power supply amount given from the outside according to the evaluation result of the power system stability degree previous evaluation process and the evaluation result of the nuclear power safety evaluation process, and decides the operation pattern of the generated power of the power generation plant on the current day, and in which the generated power of the power generation plant is adjusted by a signal from the current day power generation control instruction process”.

According to the present invention, the supply amount of the reactive power can be expanded while the soundness of the nuclear reactor and the BOP is maintained.

### BRIEF DESCRIPTION OF THE DRAWINGS

FIG. 1 is a diagram illustrating the configuration example of a power system for explaining the problem of the present invention;

FIG. 2 is a diagram illustrating the configuration example of a plant control apparatus 2 according to a first embodiment of the present invention;

FIG. 3 is a diagram illustrating the processing contents of up to a system influence degree evaluation unit 29;

FIG. 4 is a diagram illustrating the processing contents of a power generator control decision unit 26;

FIG. 5 is a diagram illustrating an example of the power factor curve of a power generator;

FIG. 6 is a diagram illustrating the configuration example of a nuclear power generation plant to be evaluated in a nuclear power safety evaluation unit 22;

FIG. 7 is a diagram illustrating the specific example of data D1 stored in a current day power generator control instruction unit 23;

FIG. 8 is a diagram illustrating the variations in reactive power Q and voltage V in a scene in which the present invention is applied and is not applied;

FIG. 9 is a diagram illustrating a graph for evaluating the soundness of a nuclear reactor with respect to a linear power density;

FIG. 10 is a diagram illustrating a graph for evaluating the soundness of the nuclear reactor with respect to a minimum critical power ratio;

FIG. 11 is a diagram illustrating a graph for evaluating the soundness of the nuclear reactor with respect to a void coefficient;

FIG. 12 is a diagram illustrating the configuration example of the power system according to a fifth embodiment; and

FIG. 13 is a diagram illustrating the effect of the fifth embodiment of the present invention.

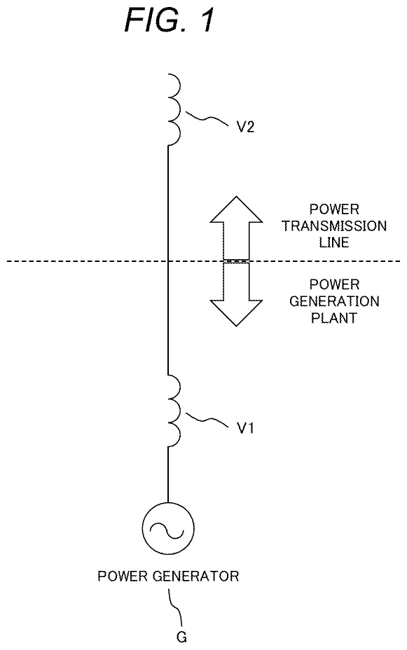

### DETAILED DESCRIPTION OF THE PREFERRED EMBODIMENTS

Hereinbelow, embodiments of the present invention will be described with reference to the drawings. It should be noted that in the present invention, as a method for changing the operation pattern of a power generator, power (any one of or both of active power and reactive power) is adjusted.

### First Embodiment

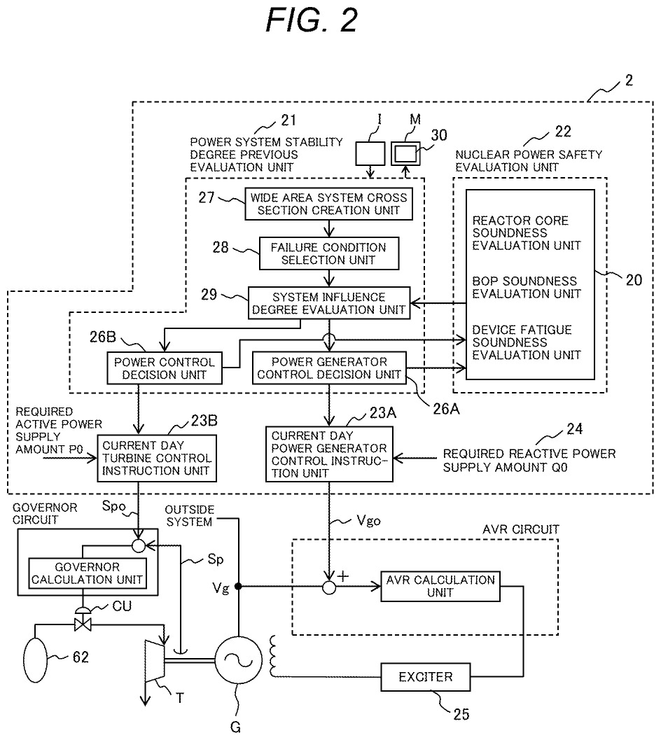

FIG. 2 is a diagram illustrating the configuration example of a plant and a plant control apparatus 2 according to a first embodiment of the present invention.

Here, the plant is an existing power generation plant (for example, a thermal power generation plant, and a nuclear power generation plant), adjusts a high pressure steam generated by a steam generator 62 such as a nuclear reactor by a steam control valve CV to give the steam to a steam turbine T, rotates a power generator G by the driving force of the steam turbine T, and on the other hand, performs excitation from an exciter 25 of the power generator G.

In addition, in the existing power generation plant, active power P of the output power given by the power generation plant is determined by the driving force of the turbine T. From this, for example, to achieve a speed and load setting signal SP0 calculated from a required active power supply amount P0 with respect to the plant from a central load dispatching center, governor calculation in which a rotation speed or the like is a return signal is executed in a governor circuit to control the opening degree of the steam control valve CV.

In addition, reactive power Q of the output power given by the power generation plant is determined by the excitation amount of the exciter 25. From this, for example, to achieve a voltage setting signal Vg0 calculated from a required reactive power supply amount Q0 with respect to the plant from the central load dispatching center, AVR calculation in which power generator terminal voltage Vg is a return signal is executed in an AVR circuit to control the excitation amount of the exciter 25.

The plant described above is controlled by the plant control apparatus 2. In this, the opening degree control of the steam control valve CV and the excitation amount control of the exciter 25 which are the main control factors of the plant are basically decided according to an instruction determined from the viewpoint of the power distribution in the entire power system (the required active power supply amount P0, the required reactive power supply amount Q0) in the outside, for example, the central load dispatching center.

With respect to this, the plant control apparatus 2 of the present invention makes the change operation plan of the outside instruction (the required active power supply amount P0, the required reactive power supply amount Q0) from the viewpoint of ensuring the safety of the nuclear power generation plant at the time of the predicted failure of the power system. It should be noted that the change of the operation of the outside instruction in the present invention can be performed with respect to any one of or both of the active power P and the reactive power Q, and in addition, the power generator to be applied may be applied by being divided into a plurality of power generators. For example, since the nuclear power generation plant is desirably operated at a constant load, the nuclear power generation plant may perform the change operation with respect to the reactive power Q and leave the change operation of the active power P to the thermal power generation plant.

In the plant control apparatus 2 of FIG. 2, for example, a computer including a CPU (Central Processing Unit), a ROM (Read Only Memory), a RAM (Random Access Memory), and a storage unit executes a plant control planning program, not illustrated, thereby achieving the function of each unit.

The plant control apparatus 2 includes a power system stability degree previous evaluation unit 21 that evaluates the stability degree of the power system, a nuclear power safety evaluation unit 22 that evaluates the soundness of the nuclear reactor and the BOP, and a current day power generator control instruction unit 23A that decides the control instruction of the power generator on the current day (in the case of the active power control, a current day turbine control instruction unit 23B that decides the control instruction of the turbine on the current day) on the basis of the results of the power system stability degree previous evaluation unit 21 and the nuclear power safety evaluation unit 22.

In response to this, the power generator G side receives the required reactive power supply amount Q0 that is the information of the reactive power supply amount required on the current day and information from a current day power generator control instruction unit 23, and changes the excitation control of the power generator by the exciter Ex. By the excitation control of the power generator, the reactive power Q outputted by the power generator (the power generator terminal voltage Vg) is adjusted.

In addition, in response to this, the turbine T side receives the required active power supply amount P0 that is the information of the active power supply amount required on the current day and information from the current day turbine control instruction unit 23B, and changes the amount of the steam flowing into the turbine by the steam control valve CV. By the steam amount control of the turbine, the active power P outputted by the power generator is adjusted. It should be noted that in the following description, the change operation plan for the reactive power Q will be described unless otherwise specified.

The power system stability degree previous evaluation unit 21 includes a wide area system cross section creation unit 27 that simulates the power system, a failure condition selection unit 28, a system influence degree evaluation unit 29 that evaluates the stability degree of the power system when a system failure occurs, and a power generator control decision unit 26 that receives the result of the system influence degree evaluation unit 29 to decide the control of the power generator.

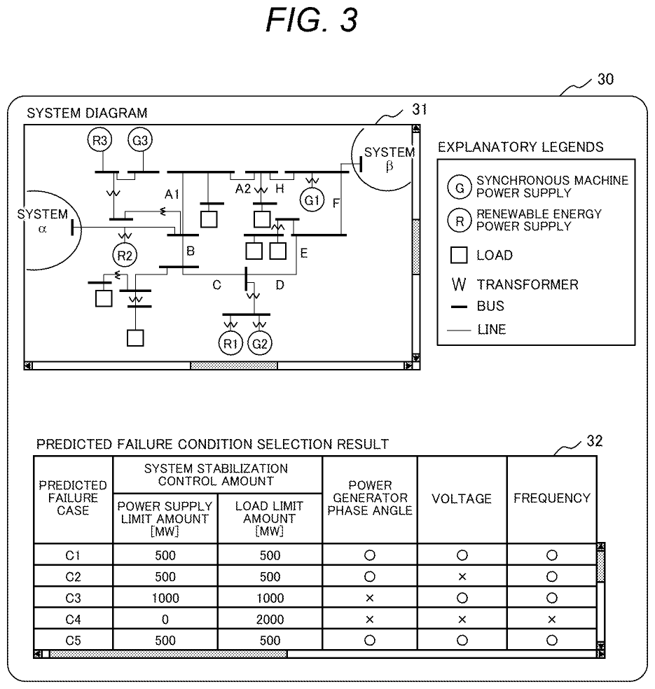

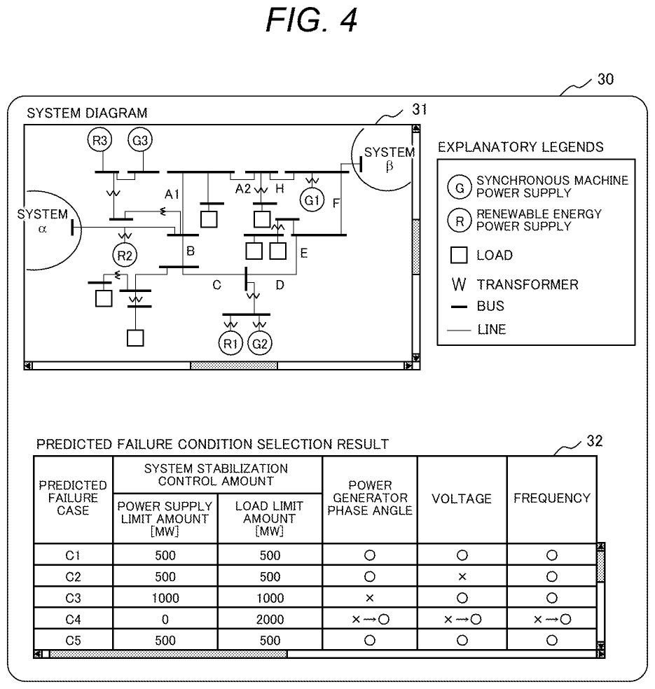

In addition, the power system stability degree previous evaluation unit 21 is connected to an input unit I such as a keyboard and an output unit M such as a monitor, an appropriate data process is instructed from the input unit I, and the processing result can be made visible to be displayed on the monitor M. On a screen 30 of the monitor M, various information of FIGS. 3, 4, and the like is made visible and displayed. Hereinbelow, the processing contents of the functions of the respective units of the power system stability degree previous evaluation unit 21 will be described with reference to FIGS. 3 and 4.

FIG. 3 is a diagram illustrating the processing contents of up to the system influence degree evaluation unit 29. On an upper portion 31 of the screen 30 of FIG. 3, the targeted power system drawn by the wide area system cross section creation unit 27 is displayed. On an upper portion screen 31, the power system configuration from the power supply (a synchronous machine power supply G and a renewable energy power supply R) to the load or other systems is simulated and displayed including the devices of the power system, such as the load, the transformer, the bus, and the line. The system configuration drawn by the wide area system cross section creation unit 27 can be changed through the input unit I by the user, as needed.

In addition, a monitor screen lower portion 32 of FIG. 3 displays, on the screen, a predicted failure condition selection result calculated by the failure condition selection unit 28 with respect to the predicted failure designated by the user through the input unit I. In this case, first, the user predicts the failure (predicted failure cases C1 . . . C5 on a screen 32) at each location of a system diagram 31 (for example, A1, A2, B, C, . . . H) through the input unit I, and inputs its contents (the place, the failure type, or the disconnection of the power transmission line, the shutdown of the power supply, and the like).

In response to this, the predicted failure condition selection result calculated by the failure condition selection unit 28 is displayed as the selection result on the screen 32. For example, at the time of this predicted system failure, the magnitudes of the power supply limit amount and the load limit amount controlled by the power system control apparatus operated to stabilize the power variation are displayed.

In addition, the system influence degree evaluation unit 29 evaluates the stability of the power system when the failure selected by the predicted failure case C (C1 . . . C5) occurs. The magnitudes of the variations in the power generator phase angle, the voltage, and the frequency, and the like which are varied at this time are list displayed as indexes representing the power system stability degree. In FIG. 3, one satisfying the reference of the stability degree (typically, the threshold value with respect to each index is determined to perform judgement according to whether the index is larger or smaller than the threshold value) is represented as a “circle”, and one not satisfying the reference of the stability degree (unstable) is represented as a “cross”. As an example, on the screen 32, the power generator phase angle, the voltage, and the frequency are represented as the indexes of the stability degree, but other stability degree except for these may be used. By confirming a predicted failure condition selection result 32, the user can visibly confirm the predicted failure case that is the severest system stable state. It should be noted that the stability degree analyzing method at the time of the predicted failure in the power system using the calculator is well known, and its detailed description is omitted in the present invention.

According to the stability degree display example of FIG. 3, all of the power generator phase angle, the voltage, and the frequency at the time of the failure in the predicted failure case C4 are displayed as the “cross”, which represents that there is a problem in the stability degree (the severest event). The power generator control decision unit 26A decides a power generator control plan that can improve the stability degree in the predicted failure case C4 by taking the evaluation result of the nuclear power safety in the nuclear power safety evaluation unit 22 into consideration in addition to the condition of the power system stability degree. It should be noted that in the same manner, the turbine control decision unit 26B decides a turbine control plan that can improve the stability degree in the predicted failure case C4 by taking the evaluation result of the nuclear power safety in the nuclear power safety evaluation unit 22 into consideration in addition to the condition of the power system stability degree. The detail of the evaluation of the nuclear power safety in the nuclear power safety evaluation unit 22 will be described later.

FIG. 4 is a diagram displaying the processing result of the power generator control decision unit 26A. According to the monitor screen lower portion 32 of FIG. 4, a stability degree 400 of the failure case C4 is changed from the “cross” display to the “circle” display. From this, it is possible to confirm that the stability degree 400 is improved even when the failure case C4 having the problem in the stability degree occurs after the power generator control decision unit 26A receives the evaluation result of the system influence degree evaluation unit 29 to change the reactive power supply amount Q0 of the power generator G.

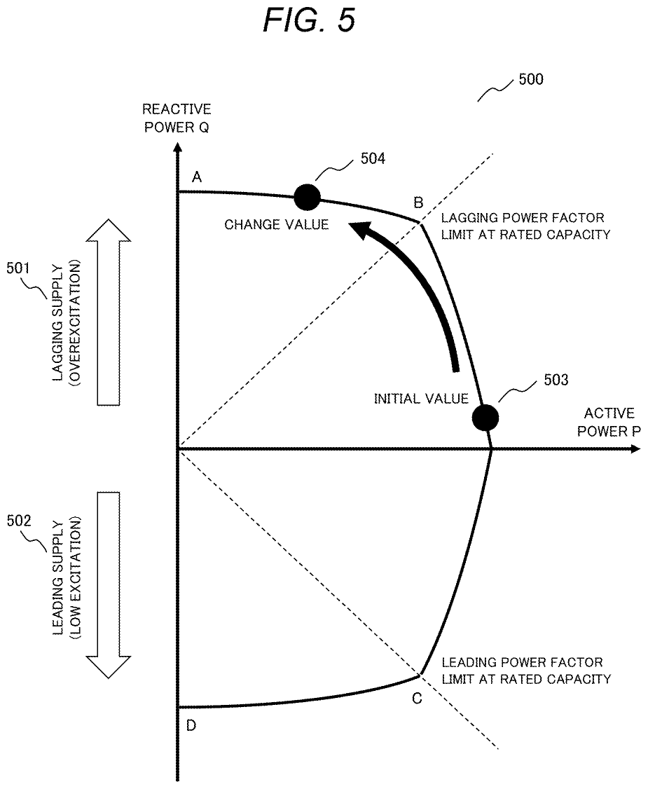

FIG. 5 is a diagram illustrating an example of the power factor curve of the power generator. How the operation pattern of the power generator G is actually changed by the power generator control decision unit 26A will be described with reference to FIG. 5. FIG. 5 illustrates the changeable range of the ratio between the active power P and the reactive power Q of the power generator called a possible output curve 500 of the power generator G. The horizontal axis indicates the active power P, and the vertical axis indicates the reactive power Q. The ratio between the active power P and the reactive power Q can be adjusted by changing a lagging supply amount 501 and a leading supply amount 502 by the excitation current of the power generator stator. Here, even when an initial value 503 of the power generator is at the position as indicated in FIG. 5, the instruction to change the power factor can change the initial value 503 to, for example, the place of the value of a change value 504 as long as the change value 504 is inside the semi-circle indicated by the ABCD in FIG. 5.

Here, the ABCD is typically decided according to the device characteristic of the power generator in such a manner that, for example, the AB is decided according to the maximum value of the excitation current flowable by the rotator coil of the power generator, the BC is decided according to the maximum value of the armature current flowable by the stator coil, and the CD is decided according to the temperature increase in the stator iron core and the stator iron core end portion.

In the operation range of a possible output curve 500 of the power generator, the power generator control decision unit 500 sets the supply amounts of the active power and the reactive power in order to improve the stability of the power system.

According to the judging result of the power system stability degree previous evaluation unit 21 described above, it is apparent that the unstable event occurs in the case 4 of the predicted severest failure, and it is found that to avoid this unstable event, as the operation pattern of the power generation plant, for example, the reactive power should be changed from the current value.

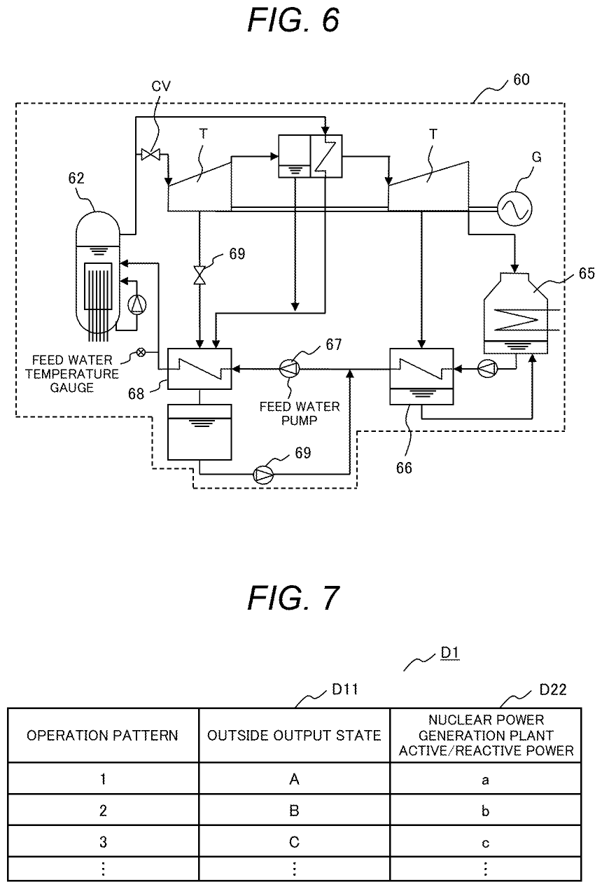

FIG. 6 illustrates the configuration example of the nuclear power generation plant to be evaluated in the nuclear power safety evaluation unit 22. The nuclear power generation plant performs the power generation by adjusting the high pressure steam generated in a nuclear reactor 62 by the steam control valve CV to give the steam to the steam turbine T for rotating the steam turbine T, and driving the power generator G. The active power P of the power generator G can be adjusted by the opening degree control of the steam control valve CV. In addition, the steam that has worked in the steam turbine T is made into condensed water by a steam condenser 65, is pressurized by a feed water pump 67, is returned from a low pressure feed water heater 66 through a high pressure feed water heater 68 to the nuclear reactor 62 again, and is circulatively used. It should be noted that part of the steam supplied to the steam turbine T is air bled from an air bleed valve 69, is used as the heated steam of the feed water in the low pressure feed water heater 66 and the high pressure feed water heater 68, and is finally returned to the steam condenser 65.

In the power generation plant, when the supply amounts of the active power P and the reactive power Q of the power generator G are changed, not only the excitation control of the power generator G and the control of the amount of the steam flowing into the turbine, but also the temporary opening and closing of the air bleed valve 69 and the feed water pump 67 included in the BOP, can be executed. In addition, in particular, in the nuclear power generation plant, since the maintaining of the soundness of the nuclear reactor 62 is the essential requirement of its operation, it is particularly important that the soundness of the nuclear reactor 62 be ensured when the operation pattern of the power generator G is changed.

For this, the nuclear power safety evaluation unit 22 of FIG. 2 judges whether the operation of the power generator G can be changed by using, as an index, whether the soundness of the operation of the nuclear reactor 62 can be ensured when the operation pattern of the power generator G is changed. Examples of the judging index in this case include the reactor core soundness, the BOP soundness, the device fatigue soundness, and the like, and the detail of these will be described.

FIG. 7 illustrates the specific example of data D1 stored in a current day power generator control instruction unit 23. The data D1 includes an outside output state D11, and nuclear power generation plant active/reactive power D12 for each operation pattern. For example, for the pattern of active power and reactive power D22 that are required according to the outside output state D11 such as the renewable energy output state of the neighboring power substation, even when the operation pattern is performed, only when the soundness of the nuclear reactor can be ensured in the evaluation in the nuclear power safety soundness unit 22, the power generator control instruction unit 23 allows the change to the operation pattern, and stores the change to the operation pattern as data.

Here, the outside output state D11 does not successively receive information from the neighboring power substation, but desirably has a form in which data can be previously extracted and the operator can ensure its soundness. As this example, for example, the renewable energy output variation from the previous weather forecast, the previously decided operation state of the neighboring power generator, and the like are considered.

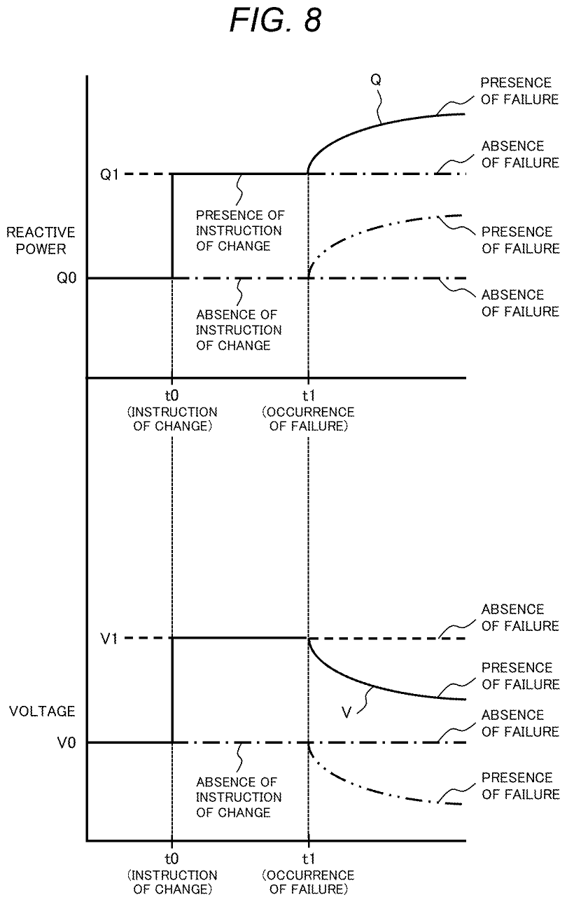

FIG. 8 illustrates the variations in the reactive power Q and the voltage V when the present invention is applied and is not applied. The upper portion of FIG. 8 illustrates the change in the reactive power Q with time, and the lower portion of FIG. 8 illustrates the change in the voltage V with time. Note that in the initial state (before time t0), the reactive power is Q0 and the voltage is V0, and at the time t0, the instruction of change is present, the reactive power is changed to Q1, and the voltage is changed to V1, and at time t1, the failure occurs.

In the present invention that receives the instruction of change, the reactive power is increased to the Q1 and the voltage is increased to the V1, and in the conventional art, the reactive power remains at the Q0 and the voltage remains at the V0. In addition, when the failure occurs at the time t1 from these states, the reactive power is increased, the voltage is decreased, and these are varied from the values Q1, V1 at the time t1.

In this way, the supply amount of the reactive power Q supplied from the power generation plant to the power system is required to be increased by the instruction of change at the time t0 in accordance with the renewable energy output variation, but when the present invention is absent, the reactive power supply amount after change is changed from the supply amount before change so as to keep the power generator voltage in the power generation plant constant. On the other hand, the supply amount of the reactive power when the present invention is present is supplied to be larger than the supply amount of the reactive power in order to maintain the voltage of the neighboring power substation.

In addition, by studying the voltage, it is found that from the voltage before the instruction of change, the voltage when the present invention is present can be further maintained as compared with the voltage when the present invention is absent.

### Second Embodiment

In a second embodiment, as an index of the nuclear power safety in a nuclear reactor safety evaluation unit 22, the reactor core soundness will be noted.

In the nuclear power safety evaluation unit 22 of the first embodiment, to decide whether or not the operation pattern of the power generator can be changed, the use of an index of soundness of nuclear reactor 20 is represented, but in the second embodiment, as the reactor core soundness, for example, a linear power density that is an output value per unit length of a fuel rod is utilized. When this linear power density exceeds the limit value, this can lead to a serious failure such as the breakage of the fuel rod.

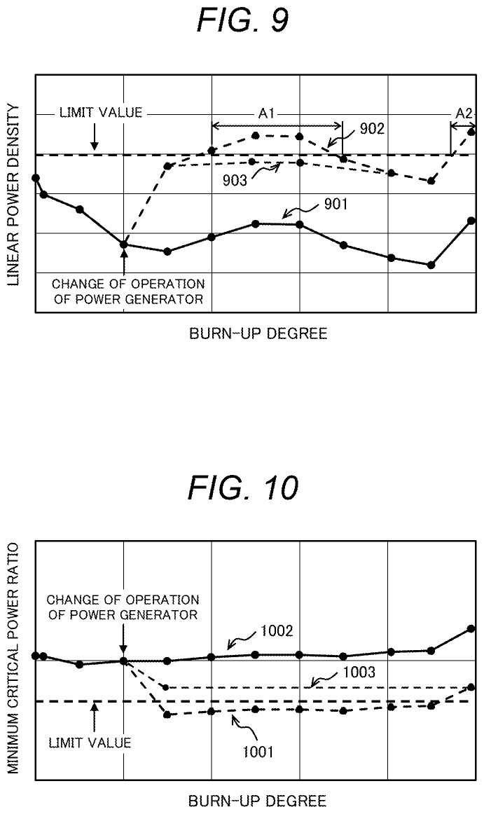

FIG. 9 is a graph for evaluating the soundness of the nuclear reactor with respect to the linear power density. In this graph, the horizontal axis indicates the burn-up degree representing the burning state of the fuel rod, and the vertical axis indicates the linear power density. As described previously, the value of the linear power density is required to be the limit value or less for operation. With the typical operation, as indicated by a linear power density 901 before the change of the operation of the power generator, its value is the limit value or less at each burn-up degree.

On the contrary, the value of a linear power density 902 after the change of the operation of the power generator can exceed the limit value, as illustrated in burn-up degree ranges A1, A2 of FIG. 9. In addition, by the change of the operation of the power generator, not only the linear power density immediately after the change of the operation, but also the linear power density when the burning proceeds, is changed. The values of these linear power densities after change are utilized, and the operation pattern of the power generator is changed in the second embodiment in the range not exceeding the limit value.

For example, the linear power density in the operation pattern after correction not exceeding the limit value in the burn-up degree ranges A1, A2 like the reference numeral 903 is searched for. In the operation pattern after correction, when, for example, the excess rate from the limit value is 5%, the adjustment of the operation pattern after the change of the operation by, for example, about 5% is repeatedly executed, so that the operation pattern after correction satisfying both of the requirement from the power system stability degree side and the requirement from the nuclear reactor safety side is searched for.

It should be noted that when the searching result cannot ensure the nuclear reactor safety, the operation pattern itself proposed from the viewpoint of the system stability degree can also be non-adopted. Alternatively, a compromise idea satisfying both of the nuclear reactor safety and the system stability degree at high level can also be made. This can also be a compromise idea in which when there is a problem in the system stability degree only for several hours in the operation pattern for one day (although the nuclear reactor safety can be ensured), this operation pattern can be allowed.

In any case, the present invention determines the operation pattern in consideration of the viewpoint of the nuclear reactor safety, and in that case, makes a change to the operation pattern determined according to the system stability degree.

### Third Embodiment

In a third embodiment, as an index of the nuclear power safety in the nuclear reactor safety evaluation unit 22, a minimum critical power ratio that is an index of the thermal margin of the fuel rod is utilized. When this minimum critical power ratio is below the limit value, the heat removal of the fuel rod is unenabled, which can lead to the serious failure such as the breakage of the fuel rod.

FIG. 10 is a graph for evaluating the soundness of the nuclear reactor with respect to the minimum critical power ratio. In this graph, the horizontal axis indicates the burn-up degree representing the burning state of the fuel rod, and the vertical axis indicates the minimum critical power ratio. As described previously, the value of the minimum critical power ratio is required to be the limit value or more for operation. With the typical operation, as indicated by a minimum critical power ratio 1001 before the change of the operation of the power generator, its value is the limit value or more at each burn-up degree.

The value of a minimum critical power ratio 1002 after the change of the operation of the power generator can be below the limit value as illustrated in FIG. 10. In addition, by the change of the operation of the power generator, not only the minimum critical power ratio immediately after the change of the operation, but also the minimum critical power ratio when the burning proceeds, is changed. The values of these minimum critical power ratios after change are utilized, and the operation pattern of the power generator is changed in the third embodiment in the range not exceeding the limit value.

Also in the third embodiment, by the adoption of the same method as the second embodiment, the operation pattern after correction so as to have a minimum critical power ratio 1003 that is the limit value or more is searched for.

It should be noted that for the linear power density with respect to the burn-up degree of FIG. 9 or the minimum critical power ratio with respect to the burn-up degree of FIG. 10, one having the appropriate characteristic should be prepared according to the case where the reactive power is adjusted, the case where the active power is adjusted, and the case where both are adjusted, and FIGS. 9 and 10 illustrate the linear power density and the minimum critical power ratio by assuming that, for example, the reactive power is changed.

### Fourth Embodiment

In a fourth embodiment, as an index of the nuclear power safety in the nuclear reactor safety evaluation unit 22, a void coefficient that is the change rate of the reaction degree of the reactor core is utilized. When this void coefficient exceeds the limit value, the output of the nuclear reactor continues to be increased at the time of introducing a positive reaction degree into the nuclear reactor, which can lead to the serious failure.

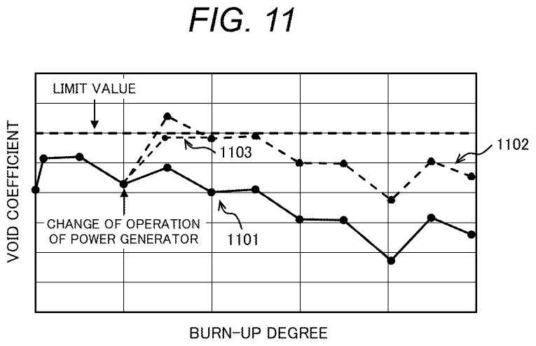

FIG. 11 is a graph for evaluating the soundness of the nuclear reactor with respect to the void coefficient. In this graph, the horizontal axis indicates the burn-up degree representing the burning state of the fuel rod, and the vertical axis indicates the void coefficient. As described previously, the value of the void coefficient is required to be the limit value or less for operation. With the typical operation, as indicated by a void coefficient 1101 before the change of the operation of the power generator, its value is the limit value or less at each burn-up degree.

The value of a void coefficient 1102 after the change of the operation of the power generator can exceed the limit value, as illustrated in FIG. 11. In addition, by the change of the operation of the power generator, not only the void coefficient immediately after the change of the operation, but also the void coefficient when the burning proceeds, is changed. The values of these void coefficients after change are utilized, and the operation pattern of the power generator is changed in the fourth embodiment in the range not exceeding the limit value. The reference numeral 1103 denotes an example of the void coefficient after the change of the operation of the power generator not exceeding the limit value.

### Fifth Embodiment

In the first embodiment, the operation pattern of the power generator is predicted from the previous renewable energy output variation, and the operation pattern for one day is previously decided. However, for example, the prediction value of the renewable energy output can become a value different from the prediction on the previous day, and the values of the required active power and the required reactive power can be different from the previous calculation values.

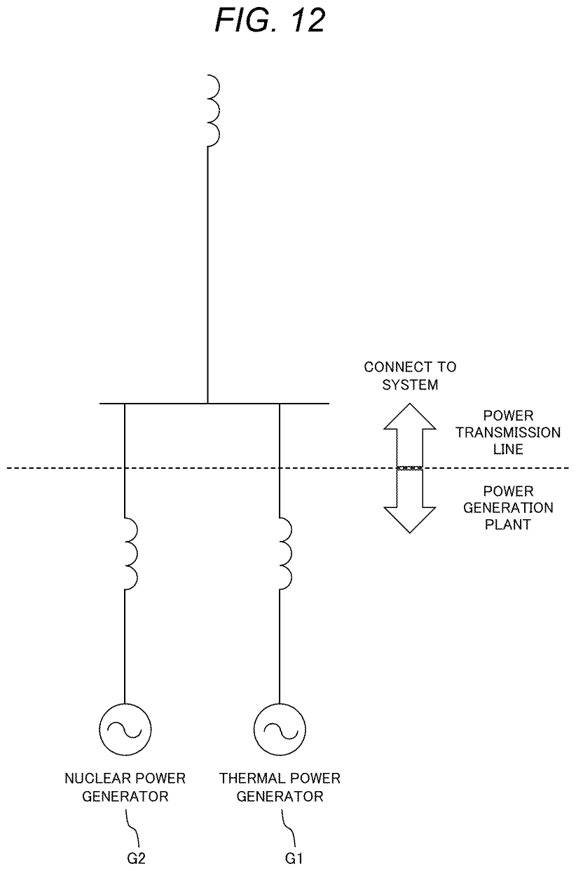

Accordingly, by cooperatively controlling a plurality of power generators, the supply amounts of the active power and the reactive power from the power generation plant are optimized. FIG. 12 illustrates the configuration of this embodiment. As illustrated in FIG. 12, a nuclear power generator G2 in which a signal from the neighboring power substation can be unable to be directly received and a thermal power generation plant G1 that can change an output by an instruction from the neighboring power substation are combined.

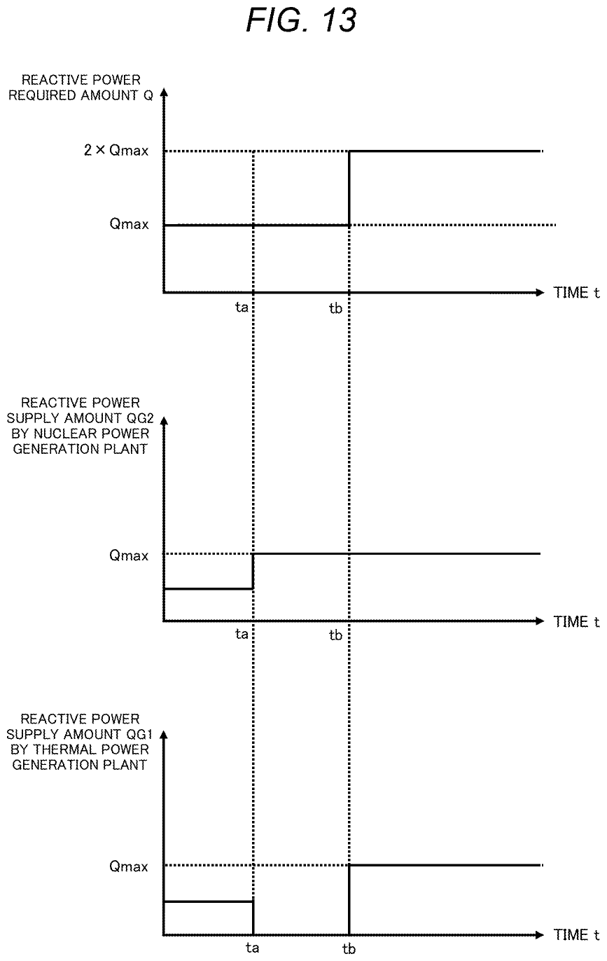

The effect obtained by this embodiment will be described with reference to FIG. 13. FIG. 13 illustrates a reactive power required amount Q required by the power system, a reactive power supply amount QG2 supplied by the nuclear power generation plant G2, and a reactive power supply amount QG1 supplied by the thermal power generation plant G1. In addition, the horizontal axis indicates time in each graph.

In the first embodiment, since the nuclear power generation plant G2 previously decides the supply amount of the reactive power, reactive power QG2 can be increased on the basis of the previous renewable energy output prediction, for example, at time ta. FIG. 13 illustrates that at the time ta, to Qmax that is the maximum reactive power amount that can be supplied by the nuclear power generation plant G2, its output is increased.

On the other hand, also at the time ta, required reactive power supply amount Q can be unchanged. In such a case, when the reactive power supply amount QG1 from the thermal power generator G1 does not change its output, the possibility that the reactive power in amount larger than the required reactive power supply amount Q may be supplied to the power system is caused.

To cope with such the state, in FIG. 13, the reactive power supply amount QG1 of the thermal power generator G1 is 0 at the time ta. By such the operation, the sum of the supply amounts of the reactive power supplied from the nuclear power generation plant and the thermal power generation plant can be adjusted so as to be equal to the value of the required reactive power supply amount Q.

Such the cooperative control can cope also with the case where the required reactive power supply amount Q cannot be supplied only by the nuclear power generation plant. For example, in FIG. 13, at time tb, the required reactive power supply amount Q is twice the reactive power supply amount that can be supplied by the nuclear power generation plant. In addition to this, by increasing the reactive power supply amount of the thermal power generation plant to the Qmax at the time tb, it is possible to perform the operation such that the sum of the reactive power supply amount QG2 supplied from the nuclear power generation plant and the reactive power supply amount QG1 supplied from the thermal power generator is equal to the reactive power supply amount Q required by the power system.

### REFERENCE SIGNS LIST

G, G1, G2: power generator
V1: voltage in power generation plant
V2: voltage in power substation past power transmission line to which power generation plant is connected
2: plant control apparatus
20: index of soundness of nuclear reactor
21: power system stability degree previous evaluation unit
22: nuclear power safety evaluation unit
23A: current day power generator control instruction unit
23B: current day turbine control instruction unit
P0: required active power supply amount
Q0: required reactive power supply amount
Ex: exciter
27: wide area system cross section creation unit
28: failure condition selection unit
29: system influence degree evaluation unit
26A: power generator control decision unit
26B: turbine control decision unit
62: nuclear reactor
CV: steam control valve
T turbine

What is claimed is:

1. A control apparatus of a power generation plant connected to a power system comprising:
a power system stability degree previous evaluation unit that evaluates a stability degree at the time of the predicted failure of the power system; a nuclear power safety evaluation unit that evaluates soundness related to the operation of a nuclear power generation plant; and a current day power generation control instruction unit that corrects a required power supply amount given from the outside according to the evaluation result of the power system stability degree previous evaluation unit and the evaluation result of the nuclear power safety evaluation unit, and decides the operation pattern of the generated power of the power generation plant on the current day, wherein the generated power of the power generation plant is adjusted by a signal from the current day power generation control instruction unit.

2. The control apparatus according to claim 1,
wherein the power system stability degree previous evaluation unit previously evaluates the stability degree of the power system at the time of the occurrence of the predicted failure in the power system, and calculates the generated power that can ensure the stability degree as the evaluation result.

3. The control apparatus according to claim 2,
at least one of a power generator phase angle, a voltage, and a frequency is used as an index of the stability degree of the power system.

4. The control apparatus according to claim 1,
wherein the nuclear power safety evaluation unit evaluates the soundness in the nuclear power generation plant when operated by correcting the required power supply amount given from the outside, and calculates the generated power that can ensure the soundness as the evaluation result.

5. The control apparatus according to claim 4,
wherein the nuclear power safety evaluation unit uses, as an index, a maximum linear power density for the soundness of the nuclear power generation plant.

6. The control apparatus according to claim 4,
wherein the nuclear power safety evaluation unit uses, as an index, a minimum critical power ratio for the soundness of the nuclear power generation plant.

7. The control apparatus according to claim 4,
wherein the nuclear power safety evaluation unit uses, as an index, a void coefficient for the soundness of the nuclear power generation plant.

8. The control apparatus according to claim 1,
wherein for the power supply amount, the power supply amount required in the neighborhood of the power generation plant with the change in a renewable energy output on the previous day is referred to.

9. A control method of a power generation plant connected to a power system by using a calculator device,
wherein a calculation unit of the calculator device includes the functions of a power system stability degree previous evaluation process that evaluates a stability degree at the time of the predicted failure of the power system, a nuclear power safety evaluation process that evaluates soundness related to the operation of a nuclear power generation plant, and a current day power generation control instruction process that corrects a required power supply amount given from the outside according to the evaluation result of the power system stability degree previous evaluation process and the evaluation result of the nuclear power safety evaluation process, and decides the operation pattern of the generated power of the power generation plant on the current day, wherein the generated power of the power generation plant is adjusted by a signal from the current day power generation control instruction process.

10. The control method according to claim 9,
wherein when the evaluation result by the nuclear power safety evaluation process cannot ensure the soundness, the adjustment of the generated power by the evaluation result of the power system stability degree previous evaluation process is not allowed.

11. The control method according to claim 9,
wherein the power adjustment given by the function of the current day power generation control instruction process is shared among and executed by a plurality of power generation plants.
